(19) United States
(12) Patent Application Publication
(10) Pub. No.: US 2015/0323861 A1
(43) Pub. Date: Nov. 12, 2015

(54) LIGHT SOURCE APPARATUS, PROJECTOR, AND METHOD FOR ILLUMINATING AN IMAGE MODULATION ELEMENT

(71) Applicant: NEC Display Solutions, Ltd., Tokyo (JP)

(72) Inventor: Hiroyuki Saitou, Tokyo (JP)

(21) Appl. No.: 14/647,426

(22) PCT Filed: Dec. 25, 2012
(86) PCT No.: PCT/JP2012/083504

§ 371 Date: May 26, 2015

(51) Int. Cl. G03B 21/20; F21V 9/16

(52) U.S. Cl. CPC G03B 21/204; F21V 9/16; G03B 21/208

(57) ABSTRACT

This light source apparatus is provided with: a fluorescent material, an excitation light source that emits excitation light for exciting the fluorescent material, a first homogeneous optical element that makes the illuminance distribution of the excitation light more homogeneous and then emits the excitation light, a second homogeneous optical element that makes the illuminance distribution of the fluorescent light emitted from the fluorescent material more homogeneous and then emits the fluorescent light, a first optical system that guides the excitation light to the first homogeneous optical element, a second optical system that guides light emitted from the first homogeneous optical element to the fluorescent material, and a third optical system that guides the fluorescent light supplied from the fluorescent material to the second homogeneous optical element.

### TECHNICAL FIELD

The present invention relates to a light source apparatus, a projector, and a method of illuminating an image modulation element.

### BACKGROUND ART

As a projector, in which light from a light source apparatus is modulated by means of a modulation element such as a liquid crystal panel or DMD (Digital Micromirror Device) to project an image, a projector is known that, as a light source, uses LEDs (Light Emitting Diodes) in place of lamps such as halogen lamps. Patent Document 1 (Japanese Unexamined Patent Application Publication No. 2004-341105) discloses a projector that takes a fluorescent material as a light source and that uses the fluorescent light emitted from the fluorescent material that is excited by irradiating the fluorescent material with a laser beam emitted from an LED.

LEDs typically suffer little deterioration over time and have a longer life than lamps. As a result, projectors that use LEDs as a light source are highly reliable and have a longer life than projectors that use a lamp as a light source. In addition, LEDs are capable of being turned on and off at high speed. As a result, projectors that use LEDs as a light source can display each color component (red-green-blue) with a high tonal range and have high color reproducibility.

### LITERATURE OF THE PRIOR ART

### Patent Documents

Patent Document 1: Japanese Unexamined Patent Application Publication No. 2004-341105

### SUMMARY OF THE INVENTION

### Problem to be Solved by the Invention

LEDs typically emit a limited quantity of light. As a result, projectors that use LEDs as a light source have difficulty in projecting images with high luminance. Here, a high-luminance image can be projected by increasing the light-emitting area of the LEDs to increase the quantity of light that is emitted from the LEDs. In the projector, however, the efficiency of utilization of light from a light source decreases if the light source etendue (the product of the light-emitting area of the light source and the emission solid angle) is not made equal to or less than the modulation element etendue (the product of the area of the modulation element and the acceptance angle that is determined by the f-number of the illumination optics that illuminates the modulation element with light from the light source). Accordingly, the quantity of light supplied from the light source can be increased by increasing the light-emitting area of the LED, but an increase of the etendue of the light source causes a reduction of light utilization efficiency.

In a projector as disclosed in Patent Document 1, which uses fluorescent light emitted from a fluorescent material that is excited by irradiating the fluorescent material with the excitation light, increasing the light-emitting area of the LED that supplies the excitation light and then condensing the light on a small area of the fluorescent material enables an increase of the quantity of fluorescent light emitted from the fluorescent material while limiting an increase of the light-emitting area in the fluorescent material.

Here, in the fluorescent material, increasing the energy of the excitation light typically lowers the wavelength conversion efficiency in the wavelength conversion of the excitation light into fluorescent light. A rise in the temperature in the fluorescent material also typically lowers the wavelength conversion efficiency.

Most of the excitation light that does not undergo wavelength conversion by the fluorescent material is converted to heat. When the wavelength conversion efficiency decreases due to the high energy of the excitation light, the proportion of excitation light that does not undergo wavelength conversion increases, resulting in an increase in the temperature of the fluorescent material and a further decrease of the wavelength conversion efficiency. The problem therefore arises that, in a light source apparatus that uses a fluorescent material as the light source, an increase in the quantity of excitation light, without an increase in the etendue of the light source, causes a decrease in the wavelength conversion efficiency of the fluorescent material.

It is an object of the present invention to provide a light source apparatus that suppresses a decrease in the wavelength conversion efficiency of a fluorescent material in a light source apparatus that uses a fluorescent material as a light source, a projector, and a method of illuminating an image modulation element.

### Means for Solving the Problem

The light source apparatus of the present invention for achieving the above object includes:
a fluorescent material;
an excitation light source that emits excitation light that excites the fluorescent material;
a first homogeneous optical element that makes the illuminance distribution of the excitation light more homogeneous and emits the excitation light;
a second homogeneous optical element that makes the illuminance distribution of the fluorescent light emitted from the fluorescent material more homogeneous and emits the fluorescent light;
a first optical system that guides the excitation light to the first homogeneous optical element;
a second optical system that guides light emitted from the first homogeneous optical element to the fluorescent material; and
a third optical system that guides fluorescent light emitted from the fluorescent material to the second homogeneous optical element.

### Effect of the Invention

The present invention enables suppressing a decrease in the wavelength conversion efficiency in a light source apparatus that uses a fluorescent material as a light source.

### BRIEF DESCRIPTION OF THE DRAWINGS

FIG. 1 is block diagram showing the principal parts of the first exemplary embodiment of a light source apparatus according to the present invention.

FIG. 2 shows the illuminance distribution of incident light to the light tunnel shown in FIG. 1.

FIG. 3 shows the shape of the incident surface and the emission surface of the light tunnel shown in FIG. 1.

FIG. 4 shows the illuminance distribution of the light emitted from the light tunnel shown in FIG. 1.

FIG. 5 shows the illuminance distribution of the incident light to the fluorescent material shown in FIG. 1.

FIG. 6 shows the illuminance distribution of light emitted from the fluorescent material shown in FIG. 1.

FIG. 7 is a block diagram showing the principal parts of a related light source apparatus.

FIG. 8 shows the illuminance distribution of incident light to the fluorescent material shown in FIG. 7.

FIG. 9 is a view for describing the difference in the illuminance distribution of incident light to the fluorescent material according to the presence or absence of the light tunnel shown in FIG. 1.

FIG. 10 is a block diagram showing the configuration of the light source apparatus of the first exemplary embodiment of the present invention.

FIG. 11 shows the illuminance distribution of light incident to light tunnel 204 shown in FIG. 10.

FIG. 12 is a block diagram showing the configuration of a projector that is equipped with the light source apparatus of the second exemplary embodiment of the present invention.

### MODE FOR CARRYING OUT THE INVENTION

### First Exemplary Embodiment

Exemplary embodiments according to the present invention are next described with reference to the accompanying drawings.

The light source apparatus of the present invention is principally used in projectors.

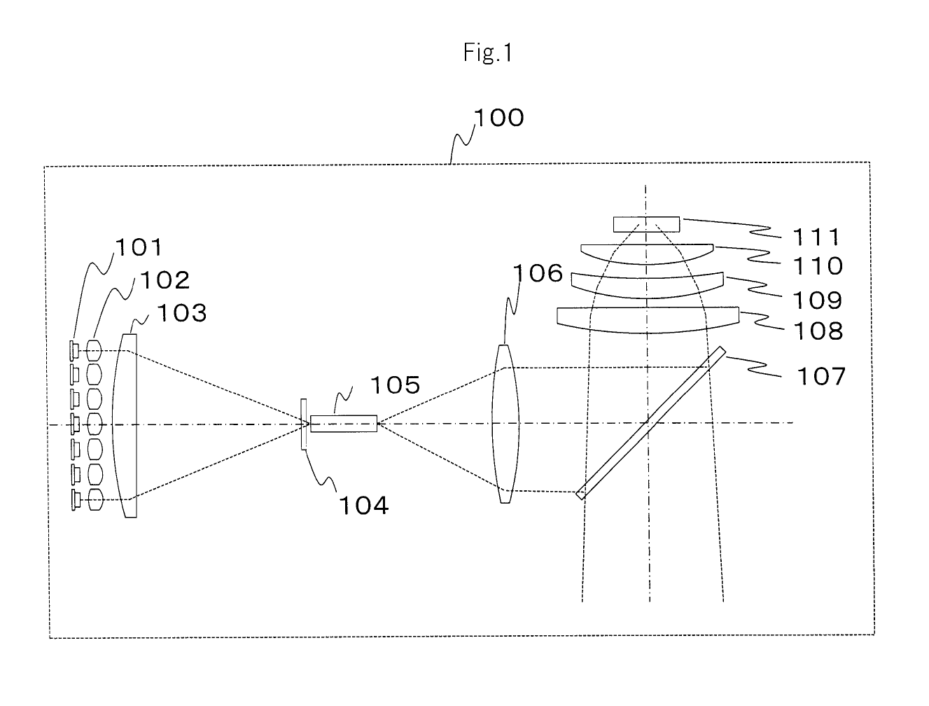

FIG. 1 is a block diagram showing the principal parts of the first exemplary embodiment of a light source apparatus according to the present invention.

Referring to FIG. 1, principal parts 100 of the light source apparatus of the present exemplary embodiment include: blue laser diode 101, collimator lens 102, lens 103, diffusion plate 104, light tunnel 105, lens 106, dichroic mirror 107, lens 108, lens 109, lens 110, and fluorescent material 111. Blue laser diode 101 is one example of the excitation light source. Lens 103 is one example of the first optical system.

Blue laser diode 101 emits blue laser light by means of the flow of current. A plurality of blue laser diodes 101 is provided and this plurality of blue laser diodes 101 is arranged on a plane.

Collimator lens 102 makes parallel (collimates) the blue laser light emitted from the plurality of blue laser diodes 101.

Lens 103 condenses the light from collimator lens 102 on the incident surface of light tunnel 105.

Diffusion plate 104 is arranged in the section preceding the incident surface of light tunnel 105 and diffuses the light that has passed through lens 103.

Light tunnel 105 is a hollow optical element having reflecting mirrors on the vertical and horizontal inner surfaces of the tunnel, and, by means of multiple reflection of incident light (light diffused by diffusion plate 104), renders the illuminance distribution of light emitted from the light tunnel more homogeneous. “More homogeneous” means that the illuminance distribution of light emitted from the light tunnel has smaller differences between the peak values and bottom values, that the illuminance distribution is smoother, or that the illuminance distribution is flatter than the illuminance distribution at the time of light incidence. Here, light tunnel 105 is one example of the first homogeneous optical element and may be a solid glass rod (rod integrator) or fly-eye lens.

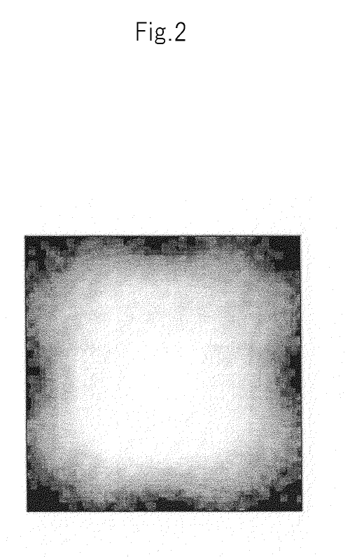

FIG. 2 shows the illuminance distribution of the light that is incident to light tunnel 105 (the first homogeneous optical element). As shown in FIG. 2, in the present exemplary embodiment, the shape of the incident light on the incident surface of light tunnel 105 (the first homogeneous optical element) is substantially square.

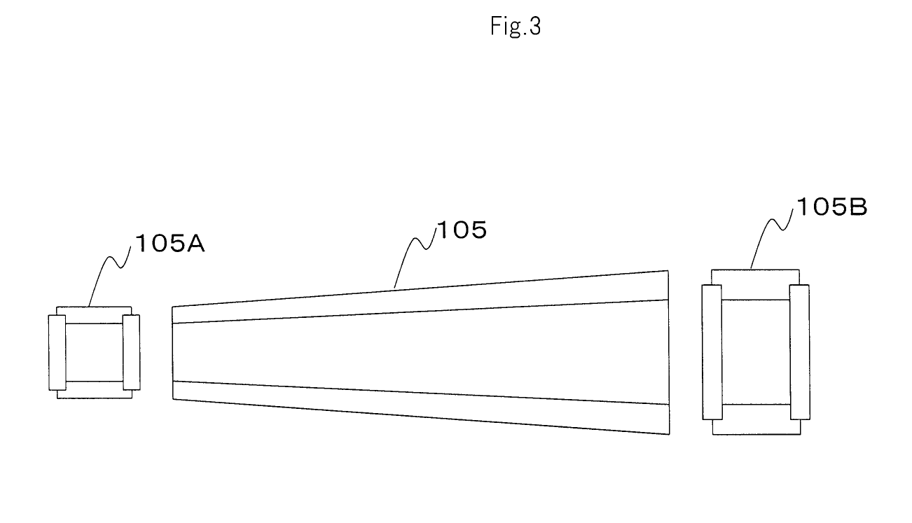

FIG. 3 shows the shapes of the incident surface and emission surface of light tunnel 105 (the first homogeneous optical element). The shapes of the incident surface and emission surface of light tunnel 105 (the first homogeneous optical element) are both rectangular. The shape of the incident surface of the light tunnel is preferably the same shape as the illuminance distribution of the incident light to the light tunnel. As described hereinabove, the shape of the incident light on the incident surface of light tunnel 105 (the first homogeneous optical element) in the present exemplary embodiment is substantially square, and as a result, the shape of incident surface 105A of light tunnel 105 (the first homogeneous optical element) is square, as shown in FIG. 3. On the other hand, the shape of emission surface 105B of light tunnel 105 (the first homogeneous optical element) is rectangular.

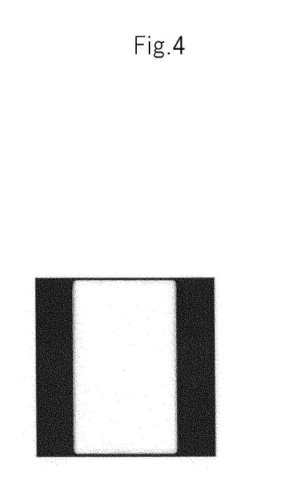

FIG. 4 shows the illuminance distribution of the emission light from light tunnel 105 (the first homogeneous optical element).

As shown in FIG. 4, light tunnel 105 (the first homogeneous optical element) makes the illuminance distribution of incident light more homogenous and emits the light.

Again referring to FIG. 1, light emitted from light tunnel 105 (the first homogeneous optical element) passes through lens 106 and proceeds to dichroic mirror 107. Dichroic mirror 107 is a mirror having the property of reflecting blue light and transmitting yellow light. In other words, dichroic mirror 107 reflects light from the excitation light source and transmits fluorescent light from fluorescent material 111. Light that is reflected by dichroic mirror 107 successively passes through lens 108, lens 109, and lens 110 to be irradiated upon fluorescent material 111. Here, lens 106, dichroic mirror 107, lens 108, lens 109, and lens 110 make up the second optical system. The second optical system causes light emitted from light tunnel 105 (the first homogeneous optical element) to form an image on fluorescent material 111. In the present exemplary embodiment, the image formation magnification of the second optical system is 0.5. Essentially, light emitted from light tunnel 105 (the first homogeneous optical element) is condensed on fluorescent material 111 by the second optical system. In other words, the second optical system reduces and projects the emission surface of light tunnel 105 (the first homogeneous optical element) on fluorescent material 111, and the emission surface of light tunnel 105 (the first homogeneous optical element) and fluorescent material 111 are therefore in a conjugate relation.

Fluorescent material 111 is constituted by fluorescent particles sealed in a medium such as a resin or a transparent inorganic material. Fluorescent material 111 is excited by the irradiation of excitation light (blue laser light) that arrives by way of the second optical system, and emits fluorescent light toward lens 110 of the second optical system.

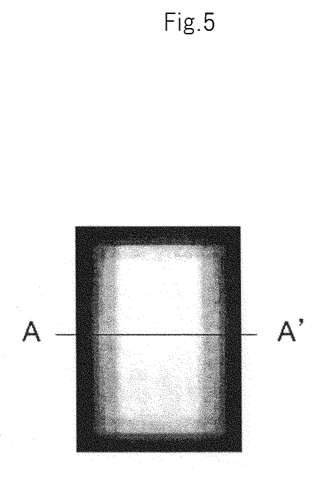

FIG. 5 shows the illuminance distribution of light incident to fluorescent material 111. A comparison of FIGS. 4 and 5 shows that light emitted from light tunnel 105 (the first homogeneous optical element) is caused to form an image on fluorescent material 111, and the shape of the region that is irradiated by incident light on fluorescent material 111 is therefore similar to the shape of the emission surface of light tunnel 105 (the first homogeneous optical element), and moreover, the illuminance distribution of incident light upon fluorescent material 111 exhibits high homogeneity, similar to the illuminance distribution of the light emitted from light tunnel 105 (the first homogeneous optical element).

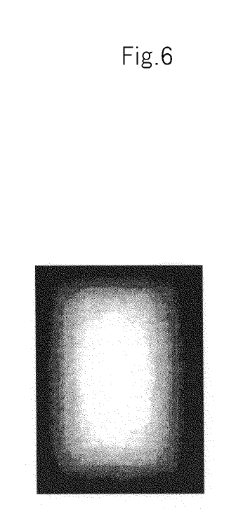

FIG. 6 shows the illuminance distribution of light emitted from fluorescent material 111. If FIGS. 6 and 5 are compared, the fluorescent light emitted from fluorescent particles is diffused in the interior of fluorescent material 111 and the shape of the emitted light is therefore not the same as the shape of the incident light in fluorescent material 111, but because the aspect ratio of the shape of the emitted light depends on the aspect ratio of the shape of the incident light, the two shapes are similar.

The differences in the illuminance distribution of incident light upon fluorescent material 111 that arise due to the presence or absence of light tunnel 105 (the first homogeneous optical element) are here described.

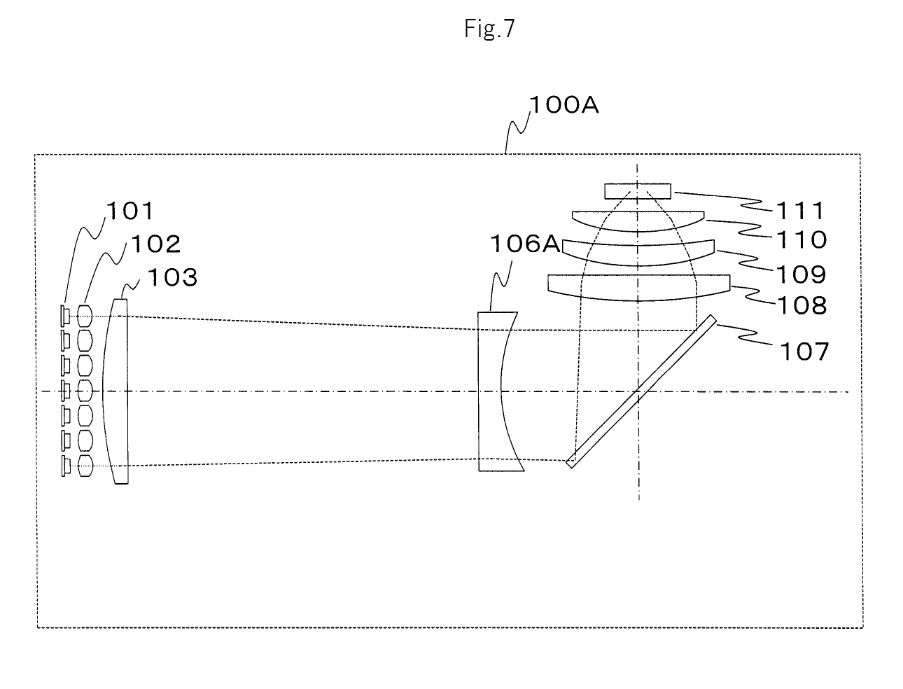

FIG. 7 is a block diagram showing the principal configuration of light source apparatus that lacks light tunnel 105 (the first homogeneous optical element). Compared to principal parts 100 of the light source apparatus shown in FIG. 1, principal parts 100A of the light source apparatus shown in FIG. 7 differ in that diffusion plate 104 and light tunnel 105 (the first homogeneous optical element) are deleted and lens 106 is changed to lens 106A. In FIG. 7, the same reference numbers are assigned to constructions that are identical to those of FIG. 1 and thus redundant explanation is avoided.

Blue laser light emitted from blue laser diode 101 is irradiated upon fluorescent material 111 by way of the path from lens 102 to lens 110.

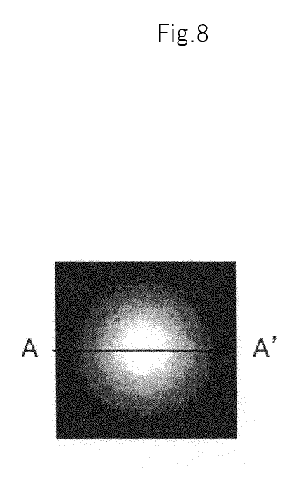

FIG. 8 shows the illuminance distribution of light incident to fluorescent material 111 shown in FIG. 7.

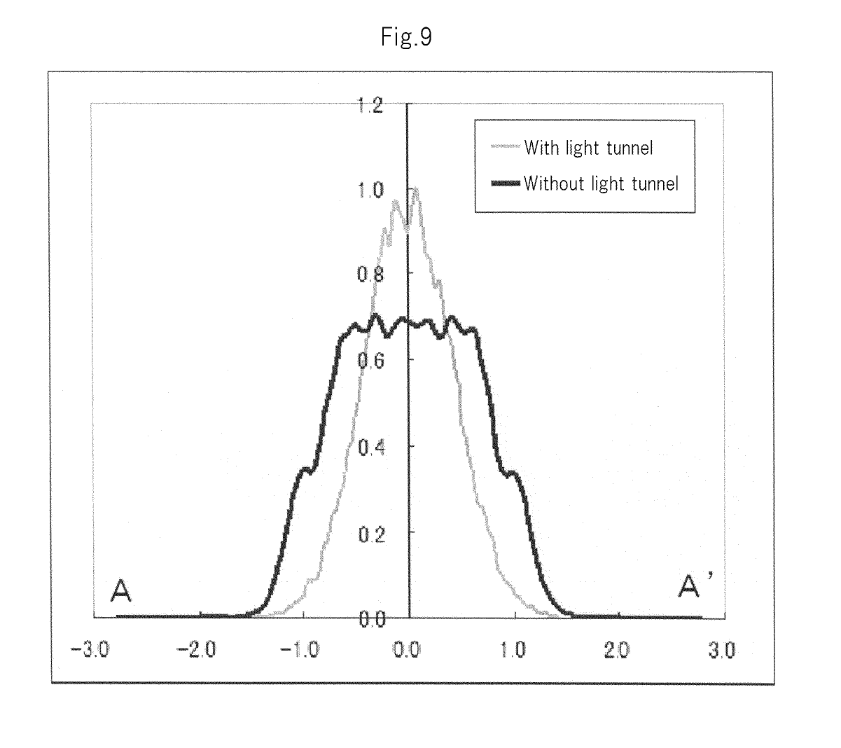

FIG. 9 is a view comparing the illuminance distributions of light incident to fluorescent material 111 along line A-A′ shown in FIGS. 5 and 8. As shown in FIG. 9, the illuminance distribution of light incident to fluorescent material 111 of principal parts 100 of the light source apparatus of the present exemplary embodiment has lower peak values and is more homogeneous than the illuminance distribution of light incident to fluorescent material 111 of principal parts 100A of the light source apparatus that lacks the light tunnel shown in FIG. 7. In other words, the energy per unit area of the excitation light that is irradiated upon fluorescent material 111 is lower, and a decrease in the wavelength conversion efficiency is therefore suppressed. In addition, because a decrease in the wavelength conversion efficiency in fluorescent material 111 is suppressed, it is less likely for excitation light that does not undergo wavelength conversion to be converted to heat. In other words, an increase in the temperature of fluorescent material 111 is suppressed, and as a result, a further decrease in the wavelength conversion efficiency of fluorescent material 111 is suppressed and the long-term reliability of fluorescent material 111 is improved.

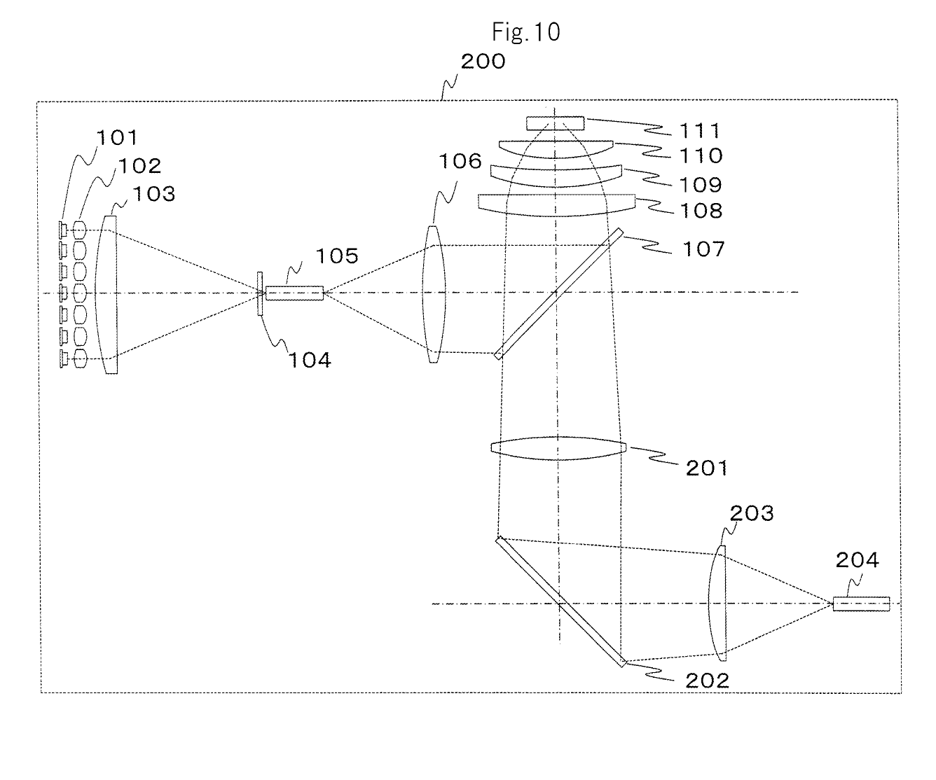

FIG. 10 is a block diagram showing the configuration of the light source apparatus of the present exemplary embodiment. In FIG. 10, identical reference numbers are assigned to constructions that are the same as constructions in FIG. 1 and the redundant explanation is avoided.

Referring to FIG. 10, light source apparatus 200 of the present exemplary embodiment differs from principal parts 100 of the light source apparatus shown in FIG. 1 in that lens 201, dichroic mirror 202, lens 203, and light tunnel 204 have been added. Light tunnel 204 is an example of the second homogeneous optical element and makes the illuminance distribution of light emitted from the light tunnel more homogeneous. “More homogeneous” means that there is a smaller different between the peak values and the bottom values in the illuminance distribution of light that is emitted from the light tunnel, or that the illuminance distribution is smoother or the illuminance distribution is flatter than the illuminance distribution at the time of incidence. A solid glass rod (rod integrator) or a set of fly-eye lenses may here be used in place of light tunnel 204 (the second homogeneous optical element). In the present exemplary embodiment, the shape of the incident surface of light tunnel 204 (the second homogeneous optical element) is similar to the shape of the emission surface of light tunnel 105 (the first homogeneous optical element).

The fluorescent light emitted from fluorescent material 111 is condensed on the incident surface of light tunnel 204 (the second homogeneous optical element) by means of lens 110, lens 109, lens 108, lens 201, and lens 203. The fluorescent light that passes through lens 201 is reflected by dichroic mirror 202 and reaches lens 203. Dichroic mirror 202 is a mirror having the properties of transmitting blue light and reflecting yellow light and functions as an optical mixing element that mixes light of different wavelengths.

Lens 110, lens 109, lens 108, dichroic mirror 107, lens 201, dichroic mirror 202, and lens 203 make up the third optical system. A portion of the third optical system is shared with a portion of the second optical system. The third optical system causes the light emitted from fluorescent material 111 to form an image on the incident surface of light tunnel 204 (the second homogeneous optical element). In the present exemplary embodiment, the image formation magnification of the third optical system is 2.5. Essentially, light emitted from fluorescent material 111 is condensed on the incident end surface of light tunnel 204 (the second homogeneous optical element) by means of the third optical system. In other words, the third optical system enlarges and projects the light-emitting region of fluorescent material 111 on the incident end surface of light tunnel 204 (the second homogeneous optical element), and fluorescent material 111 and the incident end surface of light tunnel 204 (the second homogeneous optical element) are in a conjugate relation.

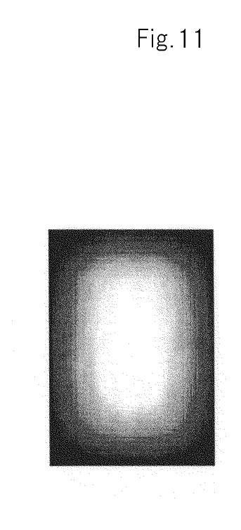

FIG. 11 shows the illuminance distribution of light incident to light tunnel 204 (the second homogeneous optical element).

If the region in which the incident light is irradiated on the incident surface of light tunnel 204 (the second homogeneous optical element) is smaller than the incident surface of light tunnel 204 (the second homogeneous optical element), a decrease will not occurs in the utilization efficiency of incident light in light tunnel 204 (the second homogeneous optical element). However, if the angle of incidence of light incident to light tunnel 204 (the second homogeneous optical element) increases, the angle of emission of light emitted from light tunnel 204 (the second homogeneous optical element) also increases, whereby the utilization efficiency of light emitted from light tunnel 204 (the second homogeneous optical element) decreases between light tunnel 204 (the second homogeneous optical element) and the projection lens when light source apparatus 200 is used in a projector. Making the irradiation region of incident light on the incident surface of light tunnel 204 equal to the incident surface of light tunnel 204 suppresses a decrease in the utilization efficiency of light in light tunnel 204.

Because the light emitted from light tunnel 105 (the first homogeneous optical element) is here caused to form an image on fluorescent material 111, and further, because the light emitted from fluorescent material 111 is caused to form an image on the incident surface of light tunnel 204 (the second homogeneous optical element), the shape of the light emitted from light tunnel 105 (the first homogeneous optical element) is similar to the shape in which incident light is irradiated on the incident surface of light tunnel 204 (the second homogeneous optical element). As a result, the emission surface of light tunnel 105 (the first homogeneous optical element) should be made similar to the incident surface of light tunnel 204 (the second homogeneous optical element) as shown in the present exemplary embodiment in order to cause the region in which incident light is irradiated on the incident surface of light tunnel 204 (the second homogeneous optical element) to match the incident surface of light tunnel 204 (the second homogeneous optical element). In addition, the image formation magnification of the third optical system should be determined such that the region in which the incident light is irradiated on the incident surface of light tunnel 204 (the second homogeneous optical element) matches the incident surface of light tunnel 204 (the second homogeneous optical element).

In this way, principal parts 100 of the light source apparatus of the present exemplary embodiment includes light tunnel 105 (the first homogeneous optical element) that makes the illuminance distribution of the light emitted from the excitation light source homogeneous and then irradiates fluorescent material 111.

As a result, the energy of the excitation light that irradiates fluorescent material 111 is decreased, thereby suppressing a decrease in the wavelength conversion efficiency.

Thus, in light source apparatus 200 of the present exemplary embodiment, the shape of the emission surface of light tunnel 105 (the first homogeneous optical element) is similar to the shape of the incident surface of light tunnel 204 (the second homogeneous optical element).

As a result, a decrease in the utilization efficiency of light in light tunnel 204 (the second homogeneous optical element) can be suppressed.

In addition, in light source apparatus 200 of the present exemplary embodiment, the region in which incident light is irradiated on the incident surface of light tunnel 204 (the second homogeneous optical element) coincides with the incident surface of light tunnel 204 (the second homogeneous optical element).

As a result, a decrease in the utilization efficiency of light in light tunnel 204 (the second homogeneous optical element) can be suppressed.

### Second Exemplary Embodiment

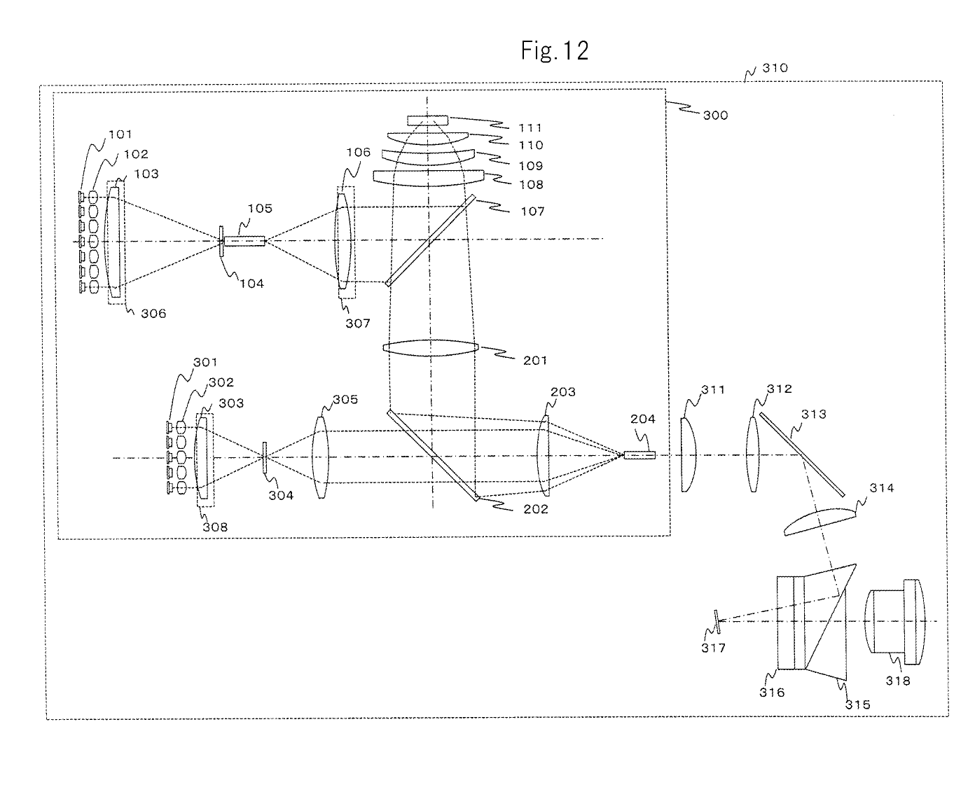

FIG. 12 is a block diagram showing the configuration of a projector that includes the light source apparatus of the second exemplary embodiment according to the present invention. In FIG. 12, the same reference numbers are assigned to constructions that are identical to those of FIG. 10 and thus redundant explanation is avoided.

Projector 310 of the present exemplary embodiment includes: light source apparatus 300, lens 311, lens 312, mirror 313, lens 314, TIR prism (Total Reflection Prism) 315, color prism 316, green DMD 317, red DMD (not shown), blue DMD (not shown), and projection lens 318. Color prism 316 is an example of a color separation element that separates white light into light of a plurality of colors such as red, blue, and green. The green DMD, red DMD, and blue DMD are examples of image modulation elements.

Light source apparatus 300 differs from light source apparatus 200 of the first exemplary embodiment in that blue laser diodes 301, collimator lenses 302, lens 303, diffusion plate 304, lens 305, movable mechanism 306, movable mechanism 307, and movable mechanism 308 have been added. Blue laser diodes 301 are an example of the projection light source.

Blue laser diodes 301 emit blue laser light by means of the flow of current. A plurality of blue laser diodes 301 are provided, and the plurality of blue laser diodes 301 are arranged on a plane.

The blue laser light emitted from the plurality of blue laser diodes 301 is made parallel by respective collimator lenses 302. The light that has been made parallel by collimator lenses 302 is condensed on diffusion plate 304 by lens 303.

After being diffused by diffusion plate 304, the light from lens 303 reaches lens 305. The light that has passed through diffusion plate 304 is condensed on the incident surface of light tunnel 204 (the second homogeneous optical element) by lens 305, dichroic mirror 202, and lens 202. Lens 303, diffusion plate 304, lens 305, dichroic mirror 202, and lens 203 make up the condensing optical system. The condensing optical system condenses the light from collimator lenses 302 on the incident surface of light tunnel 204 (second homogeneous optical element).

Dichroic mirror 202 reflects the fluorescent light that is yellow light emitted by fluorescent material 111 and transmits the blue light from blue laser diodes 301. In other words, dichroic mirror 202 acts as an optical mixer, and white light is generated by mixing the yellow fluorescent light and the blue laser light.

Light tunnel 204 makes the illuminance distribution of this white light homogeneous.

Movable mechanism 306 is provided for lens 103 that is an example of the first optical system and is capable of moving lens 103 vertically and horizontally within a plane that is perpendicular to the optical axis of light tunnel 105 (the first homogeneous optical element).

If the condensing position of lens 103 should shift from the optimum position due to the holding constructions and dimensional tolerance of the optical components, the luminance of the image projected by projector 310 drops. By moving lens 103 by means of movable mechanism 306, the condensing position of lens 103 can be adjusted to the incident end surface of light tunnel 105 (the first homogeneous optical element) and a decrease in the luminance of the image projected by projector 310 can be prevented.

Movable mechanism 307 is provided to lens 106 that makes up the second optical system and is capable of moving lens 106 horizontally and vertically within a plane perpendicular to the optical axis of light tunnel 105 (the first homogeneous optical element).

If the condensing position of the second optical system shifts from the optimal position due to the holding construction or dimensional tolerance of the optical components, the luminance of the image projected by projector 310 decreases. By moving lens 106 by means of movable mechanism 307, the condensing position of the second optical system can be adjusted to the incident end surface of light tunnel 204 (second homogeneous optical element) and a decrease in the luminance of the image projected by projector 310 can be prevented.

Movable mechanism 308 is provided to lens 303 that makes up the condensing optical system and is capable of moving lens 303 horizontally and vertically within a plane perpendicular to the optical axis of light tunnel 204 (the second homogeneous optical element).

If the condensing position of the projection light condensing optical system shifts from the optimal position due to the holding construction or dimensional tolerance of the optical components, the luminance of the image projected by projector 310 will decrease. By moving lens 303 by means of movable mechanism 308, the condensing position of the condensing optical system of lens 303 can be adjusted to the incident end surface of light tunnel 204 (the second homogeneous optical element) and a decrease in the luminance of the image projected by projector 310 can be prevented.

Lens 103 and lens 106 may also be moved along the optical axis of light tunnel 105 (the first homogeneous optical element). In addition, lens 303 may also be moved along the optical axis of light tunnel 204 (the second homogeneous optical element).

Light emitted from light tunnel 204 (the second homogeneous optical element) successively passes through lens 311, lens 312, mirror 313, lens 314, TIR prism 315, and color prism 316 and reaches the three DMDs. Color prism 316 separates the white light emitted by TIR prism 315 into green light, red light, and blue light. The green light proceeds to green DMD 317, the red light proceeds to the red DMD, and the blue light proceeds to the blue DMD. In FIG. 12, only the optical path of the green light is shown, and description of the red DMD, blue DMD, and the optical paths related to these components is here omitted.

Green DMD 317 modulates the green light from color prism 316 according to image information of the green component and emits the modulated light to color prism 316. The red DMD modulates the red light from color prism 316 according to image information of the red component and emits the modulated light to color prism 316. Blue DMD 317 modulates the blue light from color prism 316 according to image information of the blue component and emits the modulated light to color prism 316.

Color prism 316 mixes the green modulated light from green DMD 317, the red modulated light from the red DMD, and the blue modulated light from the blue DMD to generate image light that contains all of the color components and emits the image light to TIR prism 315.

The image light from color prism 316 that has passed through TIR prism 315 is irradiated to projection lens 318 and then projected onto, for example, a screen (not shown) by means of projection lens 318.

Light source apparatus 300 of the present exemplary embodiment thus includes movable mechanism 306 that adjusts the condensing position of the first optical system, movable mechanism 307 that adjusts the condensing position of the second optical system, and movable mechanism 308 that adjusts the condensing position of the light-condensing optical system.

As a result, a decrease in the luminance of the image projected by projector 310 can be prevented.

Although the invention of the present application has been described hereinabove with reference to exemplary embodiments, the invention of the present application is not limited to the above-described exemplary embodiments. The configuration and details of the invention of the present application are open to various modifications within the scope of the invention of the present application that will be clear to one of ordinary skill in the art.

All or a portion of the above-described exemplary embodiments can be described as in the following notes, but are not limited to the following notes.

### NOTE 1

A light source apparatus includes:
a fluorescent material;
an excitation light source that emits excitation light that excites the fluorescent material;
a first homogeneous optical element that makes the illuminance distribution of the excitation light more homogeneous and emits the excitation light;
a second homogeneous optical element that makes the illuminance distribution of fluorescent light emitted from the fluorescent material more homogeneous and emits the fluorescent light;
a first optical system that guides the excitation light to the first homogeneous optical element;
a second optical system that guides light emitted from the first homogeneous optical element to the fluorescent material; and
a third optical system that guides fluorescent light emitted from the fluorescent material to the second homogeneous optical element.

### NOTE 2

In the light source apparatus described in Note 1:
the shapes of the illuminance distribution of the excitation light on the incident surface of the first homogeneous optical element and on the incident surface of the first homogeneous optical element are substantially equivalent; and
the shape of the emission surface of the first homogeneous optical element and the shape of the incident surface of the second homogeneous optical element are similar.

### NOTE 3

In the light source apparatus as described in Note 1 and Note 2:
the emission surface of the first homogeneous optical element and the fluorescent material are placed in a conjugate relation by the second optical system; and
the fluorescent material and the incident surface of the second homogeneous optical element are placed in a conjugate relation by the third optical system.

### NOTE 4

The light source apparatus as described in any one of Notes 1 to 3 further includes:
a color light source that emits light of a wavelength that differs from the fluorescent light; and
a light-condensing optical system that guides light emitted from the color light source to the second homogeneous optical element.

### NOTE 5

In the light source apparatus as described in any one of Notes 1 to 4:
at least one of the first optical system, the second optical system and the light-condensing optical system is provided with means for adjusting the condensing position.

### NOTE 6

In the light source apparatus as described in any one of Notes 1 to 5, the first homogeneous optical element is a light tunnel.

### NOTE 7

In the light source apparatus as described in any one of Notes 1 to 7:
fluorescent light emitted by the fluorescent material is yellow; light emitted from the color light source is blue; and
the wavelength of the excitation light is shorter than the wavelength of yellow.

### NOTE 8

A light source apparatus includes:
a fluorescent material;
an excitation light source that emits excitation light that excites the fluorescent material;
a first light tunnel;
a homogeneous optical element;
a first lens group that guides the excitation light to the first light tunnel;
a second lens group that guides light emitted by the first light tunnel to the fluorescent material; and
a third lens group that guides fluorescent light emitted by the fluorescent material to the homogeneous optical element;
   wherein the homogeneous optical element is another light tunnel or a fly-eye lens.

### NOTE 9

A projector includes:
the light source apparatus as described in any one of Notes 1 to 8; and further includes:
a color separation element that separates light emitted from the light source apparatus into light of a plurality of colors and supplies the light;
a plurality of image modulation elements that each modulate light of each color of the plurality of colors that were separated by the color separation element; and
a projection optical element that projects light emitted from the plurality of image modulation elements.

### NOTE 10

A method of illuminating an image modulation element includes steps of:
emitting excitation light from an excitation light source;
making the illuminance distribution of the excitation light more homogeneous to irradiate a fluorescent material and causing emission of fluorescent light from the fluorescent material; and
making the illuminance distribution of the fluorescent light more homogeneous and then guiding the fluorescent light to image modulation elements.

1. A light source apparatus comprising:
a fluorescent material;
an excitation light source that emits excitation light that excites said fluorescent material;
a first homogeneous optical element that makes the illuminance distribution of said excitation light more homogeneous and emits said excitation light;
a second homogeneous optical element that makes the illuminance distribution of fluorescent light emitted from said fluorescent material more homogeneous and emits said fluorescent light;
a first optical system that guides said excitation light to said first homogeneous optical element;
a second optical system that guides light emitted from said first homogeneous optical element to said fluorescent material; and
a third optical system that guides fluorescent light emitted from said fluorescent material to said second homogeneous optical element.

2. The light source apparatus as set forth in claim 1, wherein:
the shapes of the illuminance distribution of said excitation light on the incident surface of said first homogeneous optical element and on the incident surface of said first homogeneous optical element are substantially equivalent; and
the shape of the emission surface of said first homogeneous optical element and the shape of the incident surface of said second homogeneous optical element are similar.

3. The light source apparatus as set forth in claim 1, wherein:
the emission surface of said first homogeneous optical element and said fluorescent material are placed in a conjugate relation by said second optical system; and
said fluorescent material and the incident surface of said second homogeneous optical element are placed in a conjugate relation by said third optical system.

4. The light source apparatus as set forth in claim 1, further comprising:
a color light source that emits light of a wavelength that differs from said fluorescent light; and
a light-condensing optical system that guides light emitted from said color light source to said second homogeneous optical element.

5. The light source apparatus as set forth in claim 1, wherein at least one of said first optical system, said second optical system and said light-condensing optical system is provided with means for adjusting the condensing position.

6. The light source apparatus as set forth in claim 1, wherein said first homogeneous optical element comprises a light tunnel.

7. The light source apparatus as set forth in claim 1, wherein:
fluorescent light emitted by said fluorescent material is yellow;
light emitted from said color light source is blue; and
the wavelength of said excitation light is shorter than the wavelength of said yellow.

8. A light source apparatus comprising:
a fluorescent material;
an excitation light source that emits excitation light that excites said fluorescent material;
a first light tunnel;
a homogeneous optical element;
a first lens group that guides said excitation light to said first light tunnel;
a second lens group that guides light emitted by said first light tunnel to said fluorescent material; and
a third lens group that guides fluorescent light emitted by said fluorescent material to said homogeneous optical element;
wherein said homogeneous optical element is another light tunnel or a fly-eye lens.
wherein said homogeneous optical element is another light tunnel or a fly-eye lens.

9. A projector comprising:
the light source apparatus as set forth in claim 8; and further comprising:
a color separation element that separates light emitted from said light source apparatus into light of a plurality of colors and supplies the light;
a plurality of image modulation elements that each modulate light of a respective color of said plurality of colors that were separated by said color separation element; and
a projection optical element that projects light emitted from said plurality of image modulation elements.

10. (canceled)
